(19) United States
(12) Patent Application Publication
(10) Pub. No.: US 2020/0391228 A1
(43) Pub. Date: Dec. 17, 2020

(54) NOZZLE ASSEMBLY AND METHOD FOR DELIVERY OF ADJUSTABLY-SIZED DROPLETS IN A SPRAY

(71) Applicant: Gregory Arthur Pittner, Las Vegas, NV (US)

(72) Inventor: Gregory Arthur Pittner, Las Vegas, NV (US)

(21) Appl. No.: 16/440,246

(22) Filed: Jun. 13, 2019

(51) Int. Cl. B05B 1/10; B05B 7/04

(52) U.S. Cl. CPC B05B 1/10; B05B 7/0075; B05B 7/045

(57) ABSTRACT

A nozzle assembly which is capable of delivering an airstream of droplets of liquid of a selectively-adjusted size which are accelerated to a selectively high velocity to serve purposes such as inter alia: blasting paint or particulates from a surface, washing a vehicle or other surface, fogging an area. The washing system produces adjustable-size droplets of a liquid-gas mixture for washing by combining a high velocity flow of gas carried at a first velocity through a gas conduit, with a liquid carried at a second velocity through a liquid conduit. A mixture conduit accelerates the liquid phase to nearly that of the gas phase for discharge in a controlled direction.

### BACKGROUND

### Field of the Invention

This invention relates to a method of producing large and fast-moving liquid droplets that are dispersed in a carrier gas for washing or rinsing objects such as a vehicle. The large droplets of a liquid are created within a gas by combining a fast moving flow of gas of controlled velocity and pressure carried within a gas conduit, with a liquid carried within a second conduit; with the liquid in the second conduit having a controlled pressure in order to achieve a controlled velocity which is less than that of the gas, with the gas having a turbulent flow characteristic at the location at which the liquid and gas are combined, with the liquid moving in the same direction as the gas at the point at which the liquid is combined with the gas, with the flow of liquid dividing into droplets of a controlled size following combination of the liquid and gas, and the provision of sufficient time for the gas to accelerate the velocity of the liquid droplets to nearly the same velocity as the gas within the gas conduit, with subsequent discharge of the two phases downstream from the point at which the liquid and gas are combined, and enabling such gas and liquid droplets to impact a surface which is to be cleaned.

### Description of the Related Art

Liquids, including but not limited to water, are regularly used for washing and rinsing operations. Often the liquid is mixed with chemicals which enable the liquid to be more effective for the intended task. For example, soap is often added to facilitate cleaning of a surface, working in conjunction with the water. In such a situation, the force of flowing water dislodges undesirable materials including, but not limited to, grit, grime, dirt, grease, and/or oil. The additives in the water then stabilize the removed substances so that it can be more effectively removed from the surface to which the water is applied. Water may be used without additives in situations which the water will best achieve the desired result more effectively when applied in an unadulterated or purified state.

Often, but not in all circumstances, when removing grit, grime, dirt, grease, and/or oil from a surface; the physical action of a towel, brush, or some such, similar device is used to dislodge the material to be removed. Such physical action applies a force that increases the ability of the process to dislodge the materials to be removed from the surface being washed. Once material is dislodged and exposed to the action of water containing chemicals, the surface of the particle of the material is chemically stabilized so that it has no further affinity for the surface, and can subsequently be removed by water alone. This physical washing action can be thought of as a third ingredient in the washing process. This third ingredient applied to the surface can be thought of as work, which necessarily involves the expenditure of energy. The result is that a washing operation should be thought of as generally including three components; that is, liquid, one or more chemicals, and energy.

Often a washing operation is to remove a substance, or collection of substances, that does not require added chemicals to facilitate the removal. Generally, the final step in any washing operation is a final rinse, in which case the washing operation is meant to remove all residuals that were, or may have been added, during prior steps in the washing process. In such a case, the number of ingredients in the washing process is reduced from three to two. However, a washing operation will always include energy as a necessary component without rendering the washing operation completely ineffective.

In designing a washing process, decisions will be made regarding the proper choice of liquid, chemical, and how the energy is to be applied. Just as importantly, a decision is made regarding the relative amounts of the three. In making this decision regarding relative amounts, it is well recognized that greater use of one of the three components can offset a deficiency in one or both of the other two, while achieving the same quality of the result.

In addition to decisions regarding the choice and relative amounts of liquid, chemicals, and energy; there are different methods for applying the components. This is especially true of energy, in that it may be applied in seemingly completely different ways. In the case of energy, it may be applied by the use of physical action from a brush or towel, or some such device, or in the manner in which the liquid and chemicals are applied. When a liquid is applied in the absence of a physical washing action from a towel, brush, or other similar device; and whether it contains one or more chemicals or not, it is applied in such a manner that it also contains the energy component that is so important in the washing operation. Energy is generally added to the liquid in the form of kinetic energy; that is, the energy that is contained in a material by virtue of its velocity. In other words, the energy is added by applying the liquid as a high velocity spray. By doing so, the spray is intended to hit the surface being washed such that is has sufficient velocity to dislodge any and all components to be removed more effectively. Mechanical systems known as pressure washers are commonly used to achieve a high velocity water stream which imparts sufficient energy to accomplish removal to the desired material. Additionally, it is well known that at a constant flow rate, use of a higher velocity spray yields an improved result. Likewise, use of an increased flow rate at the same velocity yields an improved result. In such case we have an excellent example of how the amount of the liquid applied can offset a deficiency in applied energy, and increased energy can offset a deficiency in the amount of liquid.

The interaction of a liquid containing energy with a surface is quite complex. A liquid droplet may be spherical or slightly spherical, which is not germane to the matter at hand. It is most important to consider the entire mass of the droplet, and its velocity, in determining the amount of energy released when the droplet comes into contact with the surface. When the droplet contacts the surface, it deforms in such a way that it forms a traveling film on the surface. If the droplet hits the surface at a perpendicular angle, it will spread equally in all directions. If the droplet hits the surface at an oblique angle, it will spread primarily in the direction of the droplet prior to hitting the surface.

Examining the manner in which the liquid travels across the surface, it is well known in the field of fluid dynamics that there is no movement in the liquid at the point of interface with a fixed surface. In pipe flow this fact is referred to as having no slip at the wall of the pipe, and is the foundation for all pressure loss calculation for flow in a pipe or other duct. The wiping or cleaning action of a liquid traveling on a fixed surface arises from the nature of the velocity profile of the liquid with changes of distance from the fixed surface. The fluid velocity is exactly zero at a fixed surface, and increases in velocity as the distance from the fixed surface increases. The faster the velocity increases with distance, the greater the shear force of the fluid on the surface, so the greater the wiping action of the fluid.

A sharper velocity gives rise to greater wiping action. The sharpness of the velocity profile can be controlled by manipulating the amount of energy expended in moving the liquid across the surface. The greater the amount of energy expended, the greater the velocity profile, and the greater the wiping action. The amount of energy can be increased by increasing the velocity of the liquid as it hits the surface. This is due to the fact that the energy contained in the liquid is proportional to the square of its velocity when it hits the fixed surface. An attempt is often made to increase the velocity of the liquid by dispensing it from a spray nozzle; however, the presence of still or slow moving air between the nozzle and the surface slows the droplets of liquid dispensed from the nozzle, partially defeating the purpose of the nozzle. This can be offset by increasing the droplet size dispensed by the nozzle, but doing so also increases the rate at which liquid is consumed.

Rather than spraying, squirting, or otherwise dispensing a liquid by itself, the liquid can be mixed with a stream of flowing gas to eliminate several deficiencies in the manner that liquids are customarily applied. Administering gas and liquid in an intimately mixed state and at the same time enables the application of increased amounts of energy to the process without increasing consumption of valuable liquid. Further, the gas may be delivered with an almost unlimited amount of energy to accomplish virtually any specific objective.

Dispensing liquid into a gas stream enables the velocity of the liquid droplets to be controlled by the velocity of the gas stream, rather than controlling the liquid velocity by using liquid at a higher rate. Using a properly designed outlet, a high liquid velocity can be maintained until the liquid makes contact with the fixed surface. In addition, a high velocity of the gas can assure that the liquid velocity profile on the surface of the object being washed is sharper than would otherwise be the case without the gas.

A second advantage arises from the use of gas and liquid together. The gas will invariably act to continuously drive the liquid from the fixed surface, thereby exposing the surface to additional, fresh liquid. When the process objective is to remove an unwanted material from a fixed surface, continuous removal of contaminated liquid and replacement with fresh liquid gives rise to the ability to remove the contaminant with a smaller quantity of liquid for each square foot of surface that is treated. This is well known in the art of Chemical Engineering. Such is best taught with an example. Suppose one is interested in extracting a water soluble substance from a solid. Given a pound of solid and ten gallons of water, the water could be used in several ways. One could add all ten gallons at one time, mix or shake the solid in the water to obtain intimate contact, and then drain the free water. Alternately, one could add the water one gallon at a time, mix or shake, remove the free water, and proceed with use of the next gallon until all the water is used. In the second case, the amount of soluble material which remains with the solid is less than in the first case, thus using the water in smaller increments, removing as much as possible before adding more water, increases the efficiency of the process. Alternately, the same removal efficiency can be obtained in the second case with the use of less total water.

A third advantage of the use of gas and liquid together is a reduction in liquid remaining on the fixed surface as it moves to the next step in the process. For those situations in which a surface goes through several process steps in succession, increased removal of the liquid will often improve the efficiency and effectiveness of the next process step.

In most applications of this invention, the gas stream used with the liquid to facilitate the process in question will be air. Since air is readily available at no cost, this affords great economy in accomplishing the objective of the process. However, in some circumstances, other gasses may be used without changing the substance of the invention.

According to the United States Census Bureau, there are over 100,000 car wash facilities in the United States, with Americans spending approximately $5.8 billion a year at such car wash facilities. Not all car washes charge the same, but the cost per wash varies from $5 to $20 or more. At an average price of $10 per wash, which may be slightly greater or lesser than the actual average, the total number of car washes per year, based on a total expenditure of $5.8 billion, is 580 million. Saving just one gallon per wash would amount to an annual saving of 580 million gallons of water.

Reported data shows that on average Californians used 85 gallons of water per person per day in 2016. This equates to about 31,000 gallons per year. Reduction of only one gallon of water consumption per car wash would thus satisfy the annual water requirements for 18,690 people consuming the same amount of water as the typical California resident during 2016.

Other proposals have involved high pressure car wash systems. The problem with these car wash systems is that they produce fine mist droplets that are not effective at removing debris from the surface of the vehicle. Even though the above cited car wash systems meet some of the needs of the market, a system and method of producing large droplets at high velocity for washing a vehicle, is still desired.

### SUMMARY

From the foregoing discussion, it should be apparent that a need exists for an improved vehicle washing system using a method of producing large droplets at a high velocity for washing a vehicle. Beneficially, such a system and method would produce large, high velocity droplets of a liquid-gas mixture for washing a vehicle; thereby avoiding the formation of very fine droplets, since larger droplets create a greater force of impact on the vehicle surface to which the liquid-gas mixture is discharged upon.

The present invention has been developed in response to the present state of the art, and in particular, in response to the problems and needs in the art that have not yet been fully solved by currently available high pressure washing devices. Accordingly, the present invention has been developed to provide a vehicle washing system using a method of producing large droplets for washing a vehicle that overcome many or all of the above-discussed shortcomings in the art.

The subject vehicle washing system is often provided with a plurality of nozzles configured to functionally execute the necessary steps of producing large droplets for washing a vehicle. These nozzles in the described embodiments include a gas source conduit that is in fluid communication with a gas source, and that carries a gas from the gas source for subsequent mixture with a liquid, and discharge as a high velocity, large droplet liquid-gas mixture.

The system also includes at least one energetic gas conduit that is in fluid communication with the gas source conduit. The energetic gas conduit has a smaller diameter than the gas source conduit, creating a first velocity for the gas flow through the energetic gas conduit.

The system also provides a liquid conduit that introduces a liquid into the energetic gas conduit; thereby creating a liquid-gas mixture. The liquid flows through the liquid conduit at a second velocity, which is slower than the first velocity of the gas flow through the energetic gas conduit. In this manner, the gas flows at a controlled velocity and pressure, and the liquid flows at a controlled velocity and pressure, which enables the liquid droplet size and final velocity of the liquid droplets to be controlled.

The system further comprises a liquid-gas conduit that carries the liquid-gas mixture from the point at which the liquid and gas are combined, and through a conduit in which the liquid droplets are accelerated to a velocity which is near that of he gas. After the liquid and gas are combined, the liquid-gas mixture passes through the conduit in which the liquid-gas mixture forms a plume in which the large droplets of liquid are concentrated in the center of the plume.

The system also provides an outlet duct from which the liquid-gas mixture ultimately discharge which can be directed at a surface such that the velocity of the gas can be used to maximize the action of the liquid droplets.

The system may also provide a spray arch that is fed by the outlet duct, and through which a vehicle can pass for the purpose of washing. The system feeds the high velocity air to form large droplet liquid-gas mixtures at multiple outlet nozzles that discharge the liquid-gas mixture directly to the vehicle surface, generally at different angles to the axis of the vehicle.

The system is further configured, in one embodiment, such that the liquid-gas mixture conduit is oriented at an oblique angle relative to the outlet duct.

In another embodiment of the present invention, the gas is air, and the liquid is water.

In a further embodiment, the internal profile of the liquid-gas conduit is similar to that of a venturi.

In a further embodiment, the internal profile of the liquid-gas conduit is similar to that of a DeLaval nozzle.

In a further embodiment, the cross sectional area of the energetic gas conduit is larger than the cross sectional area of the liquid conduit.

In further embodiments, the diameter of the gas source conduit is greater than the diameter of the energetic gas conduit.

In further embodiments, diameter of the energetic gas conduit is greater than the diameter of the liquid conduit.

In further embodiments, the liquid comprises naturally occurring materials, including minerals and ions.

In further embodiments, the liquid has been purified.

In further embodiments, the liquid comprises surfactants and washing agents.

In further embodiments, the spray arch spans the width of a vehicle.

In further embodiments, a conveyor carries the vehicle through the spray arch.

A method is provided of optimizing an average liquid droplet size in a spray, the steps of the method comprising: determining a droplet size and spray velocity optimal for treatment of an intended purpose; accelerating an airstream to a first predetermined velocity within a passageway traversing a nozzle assembly and defined by a sidewall of the nozzle assembly; accelerating a liquid stream to a second predetermined velocity within a liquid delivery tube, said second predetermined velocity less than said first predetermined velocity; discharging the liquid stream coaxially within the airstream from a nozzle at a terminal end of the liquid delivery tube to create an average droplet size of liquid within the spray; reducing the velocity of the liquid stream to reduce droplet size within the spray; and dispersing the spray against the surface.

The method may further comprise retracting the nozzle of the liquid delivery tube toward the sidewall to deliver the liquid stream noncoaxially and increase the standard deviation of the average droplet size.

The method may further comprise, in some embodiments, increasing the velocity of the airstream to reduce droplet size.

The method, in still further embodiments, comprises decreasing the velocity of the liquid stream to reduce droplet size.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view of the inside of a horizontal duct showing a liquid injected into an energetic flow of a gas;

FIG. 2 is a side view of the inside of a vertical duct into which one or more horizontal ducts is attached for the purpose of intimately mixing gas and liquid and discharging that mixture in a controlled direction;

FIG. 3 is a side view of the inside of a vertical duct into which one or more horizontal ducts is attached for the purpose of intimately mixing gas and liquid, and in which such attachment has the internal form of a venturi;

FIG. 4 is a side view of the inside of a vertical duct into which one or more horizontal ducts is attached for the purpose of intimately mixing gas and liquid, and in which such attachment has the internal form of a venturi, and in which the mixed gas and liquid discharges at an oblique angle;

FIG. 5 is a view of a vehicle being carried through of a spray arch with a compressed air device mounted at the top, a water inlet on the lower side, and with 12 attached outlet ducts used for intimately mixing air and water, and discharging that mixture;

FIG. 6 is a flowchart of an exemplary method of producing large droplets for washing a vehicle with a venturi-style vehicle washing system;

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

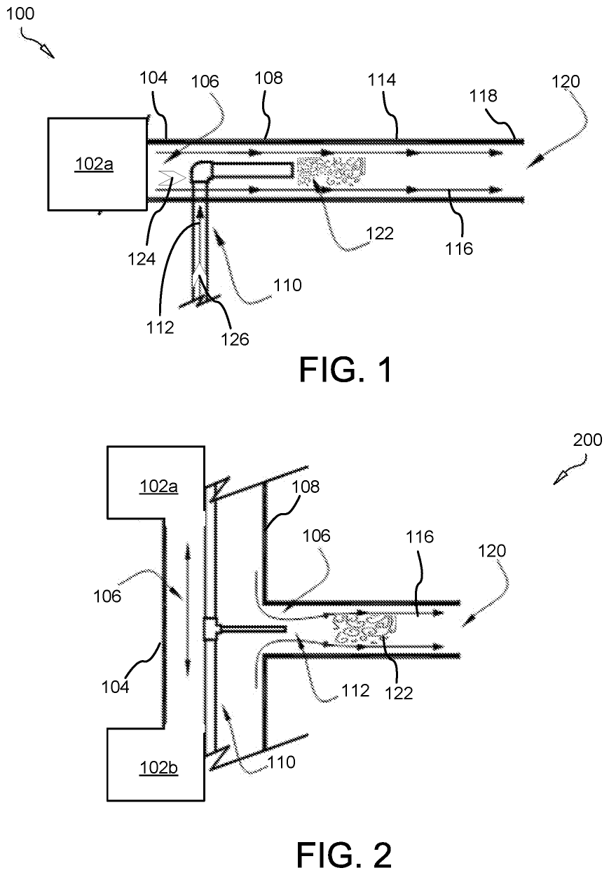

FIGS. 1-6 reference a venturi-style vehicle washing system 100 and method 600 of producing large droplets for washing a vehicle 502. As shown in FIG. 1, the vehicle 502 washing system 100, hereafter “system 100” is configured to mix a gas 106 and a liquid 112 at high velocity, such that large, high velocity droplets of a liquid-gas mixture 116 are produced for washing a vehicle 502. Specifically, the system 100 combines an energetic mixture of gas 106 and liquid 112, in which the two act in synergy to obtain results that exceed the performance level of both if each was applied separately for washing.

The system 100 utilizes different flow rates for the gas 106 and liquid 112 before mixing. The system 100 also utilizes different diameters for the conduits that carry the gas 106 and liquid 112.

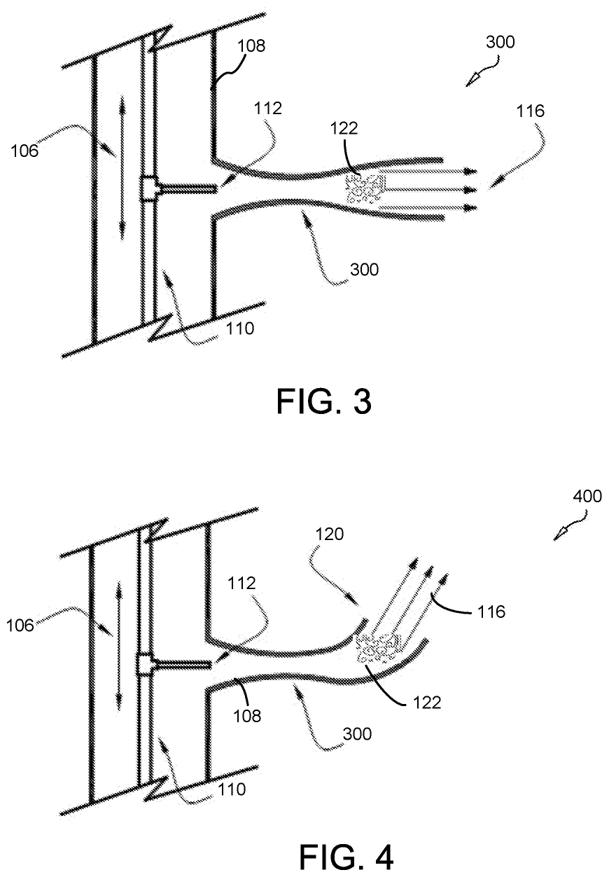

Looking now at FIG. 2, the system 100 comprises at least one gas source 102a, 102b that provides the gas 106 that combines with the liquid 112 to create the high velocity, large droplet liquid-gas mixture 116. The gas source 102a, 102b may include a gas tank, or an ambient air intake valve that ingresses air. Though in other embodiments, an inert gas may also be provided by the gas source 102a, 102b.

The gas source 102a, 102b is in fluid communication with a gas source conduit 104. The gas source conduit 104 carries the gas 106 from the gas source(s) 102a, 102b for mixture with a liquid, and subsequent discharge as a high velocity, large droplet liquid-gas mixture 116. The gas source conduit 104 may include a pipe, a tube, and a conduit known to carry a gas.

The system 100 also includes at least one energetic gas conduit 108 that is in fluid communication with the gas source conduit 104. In some embodiments, the energetic gas conduit 108 is integral to the gas source conduit 104. The energetic gas conduit 108 has a smaller diameter than the gas source conduit 104, creating a first velocity for the gas flow through the energetic gas conduit 108. The first velocity defines the rate of the gas 106 flow through the energetic gas conduit 108.

The energetic flow of gas through the gas conduit 106 exhibits what is typically referred to as turbulent flow. In turbulent flow, a multitude of very small eddy currents 122 are established in the gas stream, and such eddy currents 122 move in random directions relative to the overall direction of the gas 106.

The system 100 also provides a liquid conduit 110 that introduces a liquid into the energetic gas conduit 106. The introduction of the liquid 112 with the gas creates a liquid-gas mixture 116. When a liquid is released into such a gas stream, the eddy currents act to chop or divide the liquid into droplets.

Further, the average size of the liquid-gas mixture droplets varies with the relative amounts and velocities of the gas 106 and liquid 112 flowing through. For example, at a constant liquid flow, a more rapid gas 106 flow will reduce droplet size. At a constant gas flow, a greater liquid 112 flow will increase the average size of the droplets produced. During and after formation of liquid droplets in the gas 106, such droplets will accelerate to match the velocity of the gas stream.

It is important to note that an object of this invention is to avoid the formation of very fine droplets of liquid-gas mixture 116, since larger droplets will have a greater force of impact on any surface to which the mixture is applied. In keeping with the need to avoid formation of very fine droplets, use of a spray nozzle on the discharge conduit, described below, is undesirable.

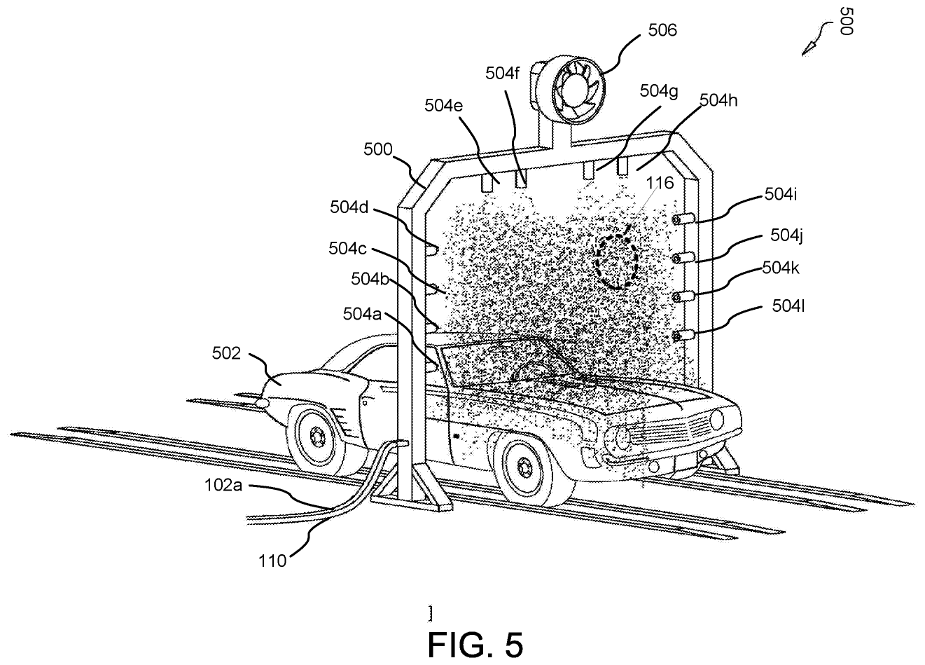

As the FIG. 3 shows, the cross sectional area of the energetic gas conduit 108 is relatively much larger than the cross sectional area of the liquid conduit 110, enabling a relatively large volumetric gas flow relative to the volumetric flow of liquid. The relatively large volume of gas flow protects the droplets from having their velocity reduced by passage through still air prior to contacting the target surface.

The liquid 112 flows through the liquid conduit 110 at a second velocity, which is faster than the first velocity of the gas flow through the energetic gas conduit 108. In this manner, the gas flows at a constant flow rate, while the liquid flows at a relatively faster flow rate. This variance in velocities works to increase the average droplet size of the liquid-gas mixture 116 at the discharge point.

Continuing with the liquid and gas flowage, the system 100 provides a liquid-gas conduit 114 that carries the liquid-gas mixture 116 from the energetic gas conduit 108. The liquid-gas conduit 114 is in fluid communication with a vena contracta 300 structure. The vena contracta 300 structure forms a constriction point towards the terminus of the liquid-gas conduit 114, which creates the conditions for increased velocity and smaller droplets of liquid-gas mixture 116. As the liquid-gas mixture 116 passes through the vena contracta 300 structure, the liquid-gas mixture 116 forms a jet flow, pressure of the liquid-gas mixture 116 drops, and velocity of the liquid-gas mixture 116 increases.

The purpose of the vena contracta 300 structure is twofold. The first purpose is to smooth the surface around which the gas flows from the gas source(s) 102a, 102b to the outlet duct 118 attachments. When the gas is made to change direction around a sharp cover, the gas flow forms a high velocity stream in the center of the attached duct. This high velocity stream is often referred to as a vena contracta 300.

At the end of the passageway, the system 100 provides an outlet duct 118 that is in fluid communication with the vena contracta 300 structure. The gas expands while flowing into the outlet duct 118 from the vena contracta 300 structure. The sudden expansion of gas creates turbulent vortexes and eddy currents 122 in the liquid-gas mixture 116.

The liquid-gas mixture 116 ultimately discharges through an outlet opening 120 that forms in the outlet duct 118. The outlet opening 120 may have a tapered configuration to create a more focused stream of liquid-gas mixture. However, the outlet opening 120 may also be adjustable to increase or decrease the diameter of the opening.

The vortexes and eddy currents 122 transform kinetic energy of the liquid-gas mixture 116 flowage to heat energy, which decreases pressure through the outlet duct 118. The decreased pressure works to increase the velocity of the liquid-gas mixture 116 discharged onto the vehicle 502. Thus, both larger droplets moving at a high velocity strike the surface of the vehicle 502.

By shaping the internal surface of the outlet duct 118, the internal surface tends to mimic the form of the vena contracta 300, kinetic energy losses are reduce, with the result that the final velocity of the gas leaving the attached duct is increased. Secondly, by releasing the liquid into the gas prior to the constriction, the liquid speed is more effectively accelerated as compared with a situation in which there was no smooth constriction.

Referring again to FIG. 2, the system 100 is shown installed in a gas source conduits 104 that holds one or more additional devices, which are not shown. Two gas source conduits 104 are shown carrying the gas to towards the energetic gas conduit 108. In such a situation, an energetic gas would be discharged into two or more mixing devices. The point in the liquid conduit 110 is the liquid discharge location. The energetic gas conduit 104 shows the gas flow passing from the gas source conduit 104 to the outlet duct 118, which is the location of discharge of the gas and liquid mixture. The outlet duct 118 serves as a conduit for liquid distribution to all mixing devices that are being used together. And the flow of air within the conduit to all such mixing devices is also shown.

Referring to FIG. 3, the system 300 is installed in a conduit that holds additional gas sources 102a, 102b, which are not shown. In such a situation, the gas dispenses into two or more gas source conduits, although this configuration could be used by itself. The point in the vena contracta 300 structure is the liquid discharge location. The gas flow is shown passing from the energetic gas conduit 104 to the outlet duct 118, which is the location of discharge of the liquid-gas mixture 116. The liquid conduit 110 is shown for liquid distribution to all other conduits. The gas source conduit 104 represents the flow of air to all such mixing devices. The system 100 in FIG. 3 differs from that in FIG. 2 in that the liquid is dispensed into the energetic gas just before passage of the gas into a smooth vena contracta 300 structure.

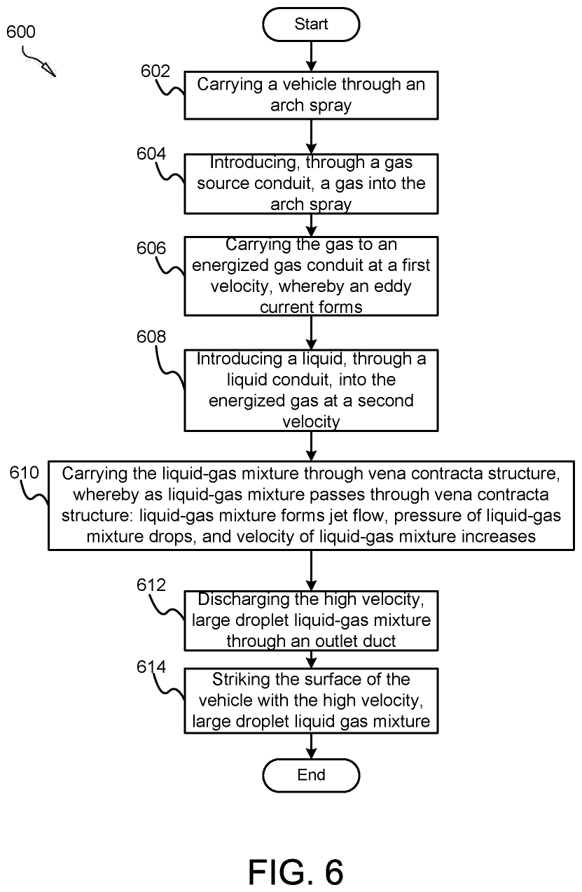

Referring to FIG. 4, the outlet duct 118 is shown with a smooth contraction. Also, the outlet discharges at an angle which is oblique to the initial flow direction of the both the gas and liquid from the manifold. The oblique angle is effective for optimizing the droplet size and velocity of the liquid-gas mixture 116. This is because, if the droplet hits the surface at an oblique angle, it will spread primarily in the direction of the droplet prior to hitting the surface of the outlet duct 118.

The vena contracta 300 structure shows the smooth constriction. The liquid conduit 110 shows the liquid discharge prior to the smooth constriction. The outlet duct 118 shows the obliquely oriented discharge after intimate mixing of the gas and liquid. The energetic gas conduit 108 shows the manifold through which liquid is distributed to more than one attachments. The gas source conduit 104 shows the movement of the gas in the manifold.

The purpose of an obliquely oriented discharge is to use the energetic gas to move the liquid off the target surface in the most beneficial direction. The most beneficial direction may be determined by several considerations, including but not limited to the particular shape of the target surface, the location of a liquid collection device such as a drain, or to avoid disturbance of the process which follows.

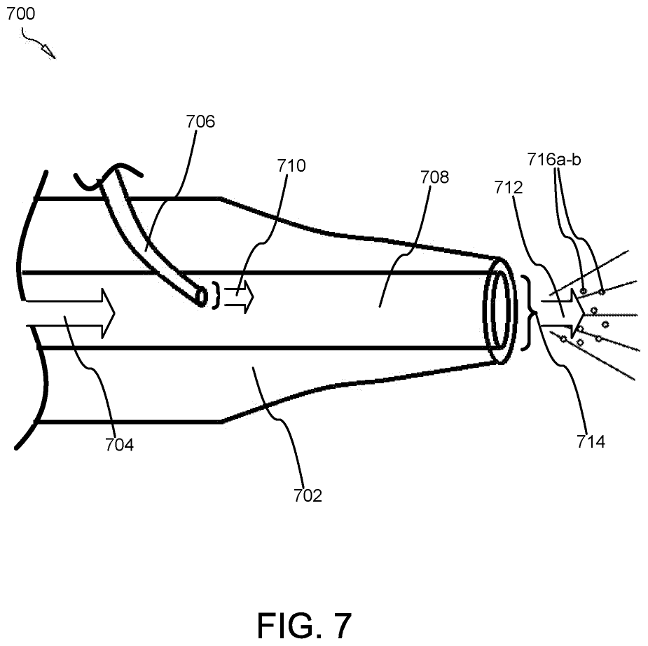

The system 100 may also provide a spray arch 500 that is fed by the outlet duct 118, and through which the vehicle 502 passes for washing. As FIG. 5 shows, the system 100 feeds the high velocity, large droplet liquid-gas mixture 116 to multiple outlet ducts 504a-1 that discharge the liquid-gas mixture 116 directly on the vehicle 502 surface, at different vantage points from the spray arch 500. For example, in one exemplary embodiment of the spray arch 500, FIG. 5 illustrates an external surface of the spray arch 500 with a compressed air device mounted at the top, a water inlet on the lower side, and with 12 attached outlet ducts 504a-1 used for intimately mixing air and water, and discharging that mixture.

FIG. 5 is a view of a vehicle being carried through of a spray arch 500 with a compressed air device 506 mounted at the top, a water inlet on the lower side, and with 12 attached outlet ducts 504a-1 used for intimately mixing air and water, and discharging the liquid-gas mixture. In a continuous process, the object, i.e., vehicle 502 on which the high velocity, large droplet liquid-gas mixture 116 is applied, may be carried on a conveyor. When this invention is applied in such a situation, the manifold duct with which the liquid-gas mixture 116 are distributed to several outlet ducts 504a-1 will be fixed in place, and the object or vehicle 502 to which the liquid-gas mixture 116 is applied moves under, past, or through the spray arch 500.

The attached mixing ducts may be oriented to deliver the gas and liquid in either the horizontal direction, vertical direction, or at any angle oblique to the major axis of the fixed structure to which they are attached. The attached ducts for mixing gas and liquid by contain a smooth constriction or not, depending on the needs of the particular application.

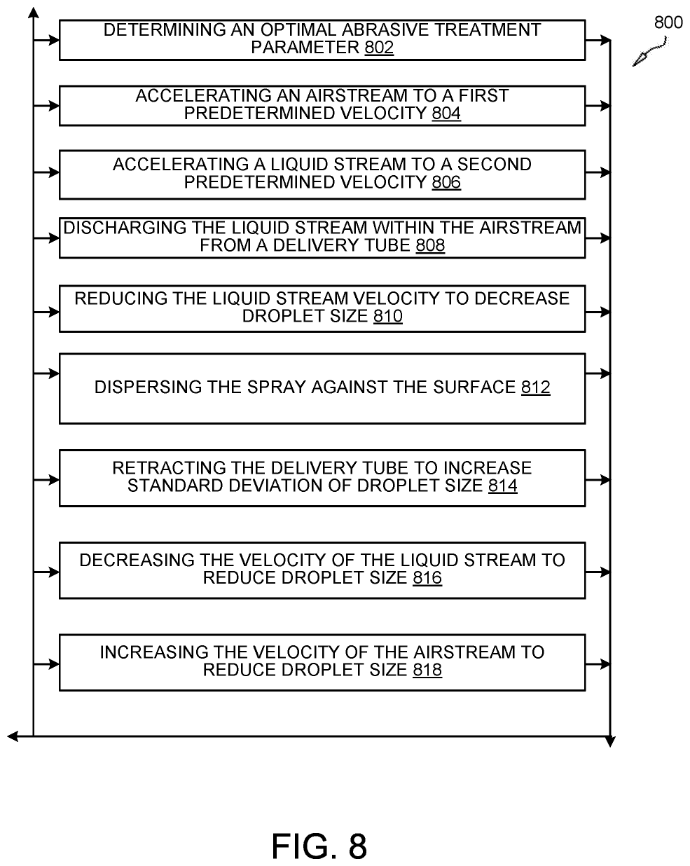

FIG. 6 references a flowchart of an exemplary method 600 of producing large droplets for washing a vehicle with a venturi-style vehicle washing system. The method may include an initial Step 602 of carrying a vehicle through an arch spray. A Step 604 includes introducing, through a gas source conduit, a gas into the arch spray. The method 600 may further comprise a Step 606 of carrying the gas to an energized gas conduit at a first velocity, whereby an eddy current forms.

A Step 608 includes introducing a liquid, through a liquid conduit, into the energized gas at a second velocity, whereby the liquid conduit has a smaller diameter than the energetic gas conduit, whereby the second velocity is greater than the first velocity, whereby the variance in velocity creates large droplets of the liquid-gas mixture. In some embodiments, a Step 610 comprises carrying the liquid-gas mixture through a vena contracta structure, whereby as the liquid-gas mixture passes through the vena contracta structure: the liquid-gas mixture forms a jet flow, pressure of the liquid-gas mixture drops, and velocity of the liquid-gas mixture increases. In some embodiments, a Step 612 may include discharging the high velocity, large droplet liquid-gas mixture through an outlet duct. A final Step 614 comprises striking the surface of the vehicle with the high velocity, large droplet liquid gas mixture. FIG. 5 shows the vehicle 502 being washed in this manner.

FIG. 7 is a sectioned view of a nozzle assembly adapted to deliver adjustably-sized water droplets in accordance with the present invention. The nozzle assembly 700 comprises a sidewall 702 which defines a centrally-disposed recess 708, canal, or passageway through which an airstream 704 passes.

The nozzle assembly 700 may terminate in a cylindrical, frustoconical, conical or otherwise-shaped distal end so as to be comprise a convergent or divergent nozzle adapted to disperse or spray an airstream with water or fluid droplets therein.

In various embodiments, water droplets and/or a water stream and/or water 710 are injected at a controlled velocity into an airstream 704. Alternatively, in place of water, the fluid being injected into the airstream 704 may comprise any other low viscosity fluid, such as various soaps and/or cleaning fluids known to those of skill in the art.

The water 710 is delivered using a water deliver means 706 coaxially into the center of the airstream 704. The delivery means 706, in this case is a water tube terminating in a roughly central position within the passageway 708. The deliver means 706 may comprise pipe, conduit, one or more nozzles, or the like fabricated from steel, titanium, aluminum, metal alloys or polymeric materials.

In various embodiments, the delivery means 706 is adapted to deliver water droplets of a predetermined size into the air stream 704. The deliver means 706 may be adapted, in some embodiments, to adjustably retract toward the sidewall 702 to inject the droplets into the center of the airstream 704 or peripherally to the center of the airstream 704. The velocity at which the airstream 704 is moving, as well as the velocity at which the water 710 is moving when injected into the airstream 704, as well as droplet size, as well as positioning of the delivery means 706 within the passage way 708, are all adjustable to create a fluid stream 712 dispersed from an orifice 714 in the nozzle assembly 100 which is itself adjustable, customizable or optimizable for a particular purpose, such as sandblasting (abrasive blasting in which water is media), vapourmatting, fogging, washing a smooth vehicular surface, washing a rough building surface, and the like. Paint removal, grime removal, dust, mud, and gum removal are all purposes served by pressure washing. Water 710 is injected into the controlled airstream 704.

In accordance with the present invention, the slower the rate at which water 710 is injected into the airstream 704, the smaller the droplets 716 within the fluid stream 712, spray or plume are. The flow rate (or velocity) of the water 710 may be selectively adjusted to control/adjust the droplet 716 size for a particularized purpose, such as, by way of example, washing triple foam from a vehicular surface in a venturi-style car wash—reducing the total volume of water needed to accomplish a particular purpose. In this manner, it is an object of the present invention to provide water-conserving technology to pressure wash and pressure water operators.

FIG. 8 is a flow chart of the steps of a method 800 for adjusting the droplet size of a liquid in a spray in accordance with the present invention.

Step 802 comprises determining a droplet size and spray velocity optimal for treatment of an intended purpose through experimentation or reference to documentation. Droplet size 716 should be smaller for fogging purposes than for pressure washing pressures, and smaller for pressure washing purposes than for abrasive treatment purposes such as paint removal.

As indicated at Step 804, the airstream 704 is accelerated to a first predetermined velocity within a passageway 708 traversing the nozzle assembly 700 as defined by a sidewall 702 of the nozzle assembly 700. For instance, the first predetermined velocity may be five ten per second for pressure washing but five feet per second for fogging applications.

At Step 806, the liquid stream is accelerated to a second predetermined velocity within a liquid delivery tube, said second predetermined velocity less than said first predetermined velocity. For instance, if the first predetermined velocity is ten feet per second, the second predetermined velocity may be eight feet per second or any where else between 0 ft/s and 10 ft/s.

The liquid stream 710 is discharged coaxially within the airstream 704 from a terminal end of the liquid delivery tube 706 to create an average droplet 716 size of liquid within the spray 712.

At 808, the velocity of the liquid stream may be reduced to reduce droplet 716 size within the spray 712.

The spray 712 is dispersed from the orifice 714 against the surface intended for treatment, such as a vehicular paint surface during washing operations.

In further embodiments of the method 800, the nozzle (and/or terminal end) of the liquid delivery tube 706 is retracted toward the sidewall 702 to deliver the liquid stream 712 noncoaxially into the airstream 702 and to increase the standard deviation of the average droplet size—meaning to increase the diversity of droplet 716 size within the spray 712 for using a spray 712 for multipurpose treatment purposes, such as treating a surface with a variety of rough conditions for which multiple droplet sizes are optimal.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A nozzle system comprising:
a gas source conduit carrying a gas at a controlled velocity and pressure;
a liquid conduit being in fluid communication with the gas conduit, the liquid flowing through the liquid conduit at a controlled velocity and pressure, the liquid conduit discharging liquid into the gas conduit in the same direction as the gas flow, the liquid velocity being less than the gas velocity at the point of discharge into the gas;
a liquid-gas conduit in fluid communication with both the liquid conduit and the gas conduit and which is of sufficient length to enable the liquid to be accelerated to a velocity that is nearly equal to the velocity of the gas;
an outlet from the liquid-gas conduit that can direct the liquid-gas flow to a surface for the purpose of cleaning the surface.

2. The system of claim 1, further comprising more than one nozzle in fluid communication with both the liquid and the gas source conduit.

3. The system of claim 1, wherein the diameter of the gas source conduit is greater than the diameter of the liquid-gas conduit.

4. The system of claim 1, wherein the gas is air.

5. The system of claim 1, wherein the liquid-gas conduit has the inside shape of a venturi.

6. The system of claim 1, wherein the liquid-gas conduit has the inside shape of a DeLaval nozzle.

7. The system of claim 1, wherein the liquid comprises water containing cleaning chemicals.

8. The system of claim 1, wherein the liquid comprises water containing vehicle waxes.

9. The system of claim 1, wherein the liquid is water containing naturally occurring minerals and ions.

10. The system of claim 1, wherein the liquid is purified water.

11. A method of optimizing an average liquid droplet size in a spray, the steps of the method comprising:
determining a droplet size and spray velocity optimal for treatment of an intended purpose;
accelerating an airstream to a first predetermined velocity within a passageway traversing a nozzle assembly and defined by a sidewall of the nozzle assembly;
accelerating a liquid stream to a second predetermined velocity within a liquid delivery tube, said second predetermined velocity less than said first predetermined velocity;
discharging the liquid stream coaxially within the airstream from a nozzle at a terminal end of the liquid delivery tube to create an average droplet size of liquid within the spray;
reducing the velocity of the liquid stream to reduce droplet size within the spray;
dispersing the spray against the surface.

12. The method of claim 11, further comprising retracting the nozzle of the liquid delivery tube toward the sidewall to deliver the liquid stream noncoaxially and increase the standard deviation of the average droplet size.

13. The method of claim 11, further comprising increasing the velocity of the airstream to reduce droplet size.

14. The method of claim 11, further comprising decreasing the velocity of the liquid stream to reduce droplet size.
